(19) United States
(12) Patent Application Publication
(10) Pub. No.: US 2006/0128385 A1
(43) Pub. Date: Jun. 15, 2006

(54) Method and system for MIPv4-based fast handoff between heterogeneous networks

(76) Inventors: Hyun-Woo Lee, Daejeon (KR); Won Ryu, Daejeon (KR); Jin-Seong Cho, Yongin (KR); Woo-Jin Choi, Seoul (KR); Han-Sup Lee, Sungnam (KR); Ho-Tak Hwang, Sungnam (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/145,127

(22) Filed: Jun. 3, 2005

(30) Foreign Application Priority Data
Dec. 13, 2004 (KR) 10-2004-0104957

(51) Int. Cl. H04Q 7/20

(52) U.S. Cl. 455/436; 455/443

(57) ABSTRACT

Disclosed herein is a method and system for Mobile Internet Protocol version 4 (MIPv4)-based fast handoff between heterogeneous networks. The method includes the first step of an Mobile Station (MS) acquiring information about a second Foreign Agent (FA) pertaining to a second wireless network to be newly accessed from a first FA pertaining to a first wireless network that is different from the first wireless network and is previously accessed; the second step of the MS requesting registration from an integrated Home Agent (HA) through the first FA and the second FA; the third step of generating a temporary tunnel between the first FA and the second FA; and the fourth step of the HA transmitting a reply to the registration request to the MS through the second FA.

### RELATED APPLICATIONS

The present application is based on, and claims priority from, Korean Application Number 2004-0104957, filed Dec. 13, 2004, the disclosure of which is incorporated by reference herein in its entirety.

### BACKGROUND OF THE INVENTION

1. Field of the Invention

The present invention relates generally to a method and system for Mobile Internet Protocol version 4-based fast handoff between heterogeneous networks and, more particularly, to a method and system for Mobile Internet Protocol version 4-based fast handoff in regions where heterogeneous networks, such as a portable Internet service network, a Code Division Multiple Access2000 wireless Internet access service network, and an IEEE 802.11-based public wireless local area network service network, overlap each other.

2. Description of the Related Art

Generally, handoff is a scheme for maintaining the connectivity of communication path and service as a mobile terminal moves around. Conventional handoff schemes include a low latency handoff scheme that is applied to the Mobile Internet Protocol version 4 (MIPv4) of a network layer and a fast handoff scheme that is applied to Mobile Internet Protocol version 6 (MIPv6).

The low latency handoff scheme that is one of the conventional handoff schemes and is applied to MIPv4 includes a pre-registration scheme that performs mobile Internet Protocol (IP) registration first and a post-registration scheme that uses a Bi-directional Edge Tunnel (BET) between Foreign Agents (FAs). All of the two schemes perform handoff using an L2 trigger. The post-registration scheme chiefly uses a method of using a network trigger. In contrast, in the case of the pre-registration scheme, there exists a method of using a mobile trigger. The L2 trigger refers to information relating to an indication transferred from a layer 2 to a layer 3, and functions to inform the layer 3 of a specific event that happens in the layer 2. L2 triggers are classified according to the event that drives the L2 triggers, and are divided into a source trigger, a target trigger, a link down trigger, a link up trigger and a mobile trigger.

However, in the case of the post-registration scheme, a handoff procedure is carried out only by operations between FAs without the involvement of a terminal, so that a mobile trigger is not applied. In the case of the pre-registration scheme, a serious problem may occur such that a service is discontinued due to the loss of a packet if the L2 handoff is completed before mobile IP registration.

### SUMMARY OF THE INVENTION

Accordingly, the present invention has been made keeping in mind the above problems occurring in the prior art, and an object of the present invention is to provide a method and system for supporting stable and fast handoff between heterogeneous networks on an MIPv4 basis without the loss of packets or interruption.

In order to accomplish the above object, the present invention provides a method for MIPv4-based fast handoff between heterogeneous networks, including the first step of an Mobile Station (MS) acquiring information about a second Foreign Agent (FA) pertaining to a second wireless network to be newly accessed from a first FA pertaining to a first wireless network that is different from the first wireless network and is previously accessed; the second step of the MS requesting registration from an integrated Home Agent (HA) through the first FA and the second FA; the third step of generating a temporary tunnel between the first FA and the second FA; and the fourth step of the HA transmitting a reply to the registration request to the MS through the second FA.

In order to accomplish the above object, the present invention provides a system for MIPv4-based fast handoff between heterogeneous networks, including an MS capable of accessing a plurality of heterogeneous networks; a first FA pertaining a first wireless network that is previously accessed by the MS, the first FA being configured to process routing and mobile IP and to provide information about a second wireless network that is different from the first wireless network and will be accessed by the MS; a second FA pertaining to the second wireless network, the second FA being configured to process routing and mobile IP and to generate a tunnel through which packets will be transferred to the MS; and an integrated HA connected to the plurality of heterogeneous networks through an IP network, the integrated HA being configured to register information about a location of the MS so as to continuously provide a service as the MS moves through the heterogeneous networks.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a system for MIPv4-based fast handoff between heterogeneous networks in accordance with an embodiment of the present invention;

FIG. 2 is a diagram showing a message call processing flow in a method for MIPv4-based fast handoff between heterogeneous wireless networks in accordance with an embodiment of the present invention;

FIG. 3 is a diagram showing the format of a proxy router solicitation message according to an embodiment of the present invention;

FIG. 4 is a diagram showing the format of a proxy router advertisement message according to an embodiment of the present invention;

FIG. 5 is a diagram showing the format of a registration request message that is added with a fast handoff extension and is used in MIPv4, in accordance with an embodiment of the present invention; and

FIG. 6 is a diagram showing the format of a registration reply message that is added with a fast handoff acknowledge extension and is used in MIPv4, in accordance with an embodiment of the present invention.

### DESCRIPTION OF THE PREFERRED EMBODIMENTS

Reference now should be made to the drawings, in which the same reference numerals are used throughout the different drawings to designate the same or similar components.

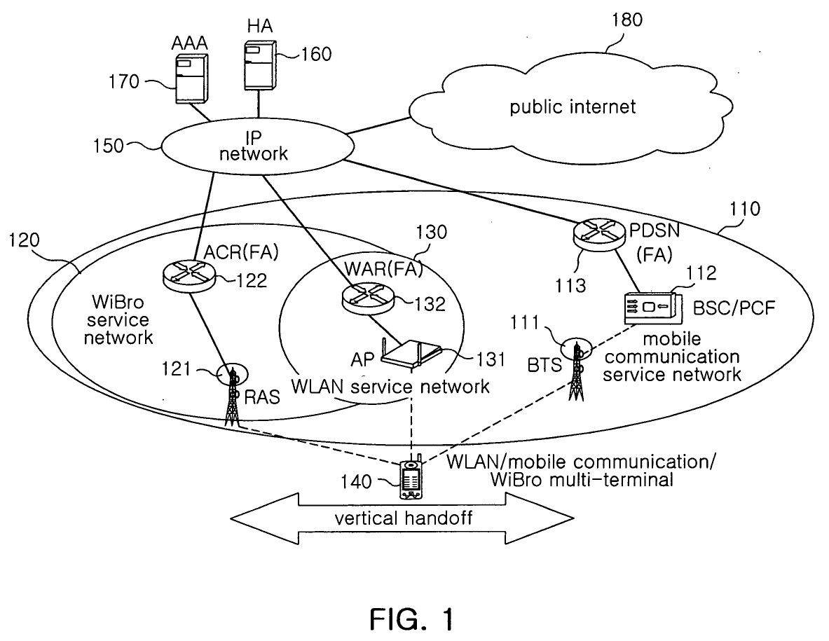

FIG. 1 is a configuration diagram showing a system for MIPv4-based fast handoff between heterogeneous networks in accordance with an embodiment of the present invention.

Referring to FIG. 1, the system for MIPv4-based fast handoff between heterogeneous wireless networks in accordance with the embodiment of the present invention includes a plurality of heterogeneous wireless networks 110, 120 and 130 that overlap each other, an MS 140 that is capable of accessing the heterogeneous networks 110, 120 and 130, an integrated HA 160 that connects via an IP network 150 using IP, and an integrated AAA server 170. The IP network 150 is connected to the public Internet 180.

The plurality of heterogeneous wireless networks 110, 120 and 130 may include a Code Division Multiple Access (CDMA) mobile communication wireless Internet access service network 110, a portable Internet service network 120 (for example, a WiBro network) and an IEEE 802.11-based Public Wireless Local Area Network (PWLAN) service network 130. The CDMA mobile communication wireless Internet access service network 110 includes a Base Transceiver Station (BTS) 111 that the MS accesses, a Base Station Controller/Packet Control Function (BSC/PCF) 112 that is in charge of the control and management of the BTS and the control of packets, and a Packet Data Serving Node (PDSN) 113 that is in charge of the routing of packets and functions as an FA. The portable Internet service network 120 includes a Radio Access (RAS) 121 through which the MS 140 accesses the portable Internet service network 120, and an Access Control Router (ACR) 122 that is in charge of the routing of packets and functions as an FA. The PWLAN service network 130 includes an Access Point (AP) 131 through which the MS 140 accesses the PWLAN service network 130, and a WLAN Access Router (WAR) 132 that is in charge of the routing of packets and functions as an FA.

The PDSN 113, the WAR 132 and the ACR 122 perform an FA function of carrying out work related to routing and mobile IP as the MS 140 moves through the heterogeneous networks 110, 120 and 130. To continue service in the overlapping regions between the heterogeneous networks 110, 120 and 130, a heterogeneous network access function and handoff between different frequencies must be provided. Such type of handoff is called “vertical handoff.” It is assumed that the CDMA mobile communication Internet access service network 110 can be accessed from anywhere. The CDMA mobile communication Internet access service network 110 may be constructed in a form that complements the portable Internet service network 120 and compensates for the shadow area of the PWLAN service network 130.

The MS 140 is a multi-mode terminal that supports multiple wireless access to the heterogeneous networks 110, 120 and 130, that is, the CDMA mobile communication wireless Internet access service network 110, the portable Internet service network 120 and the IEEE 802.11-based PWLAN service network 130. The MS 140 contains a wireless access unit (not shown) that is capable of accessing the heterogeneous networks 110, 120 and 130, and message exchange and other operations can be smoothly performed because the wireless access unit is operated on an IP basis. The integrated HA 160 functions to register the location of the MS 140. That is, whenever the MS 140 moves into a new network, the MS 140 acquires a new care-of address and performs a registration procedure to inform the integrated HA 160 of the acquisition of the new care-of address. The integrated AAA server 170 accesses the heterogeneous networks 110, 120 and 130 using the MS 140, and functions to provide AAA services to subscribers who want to use service.

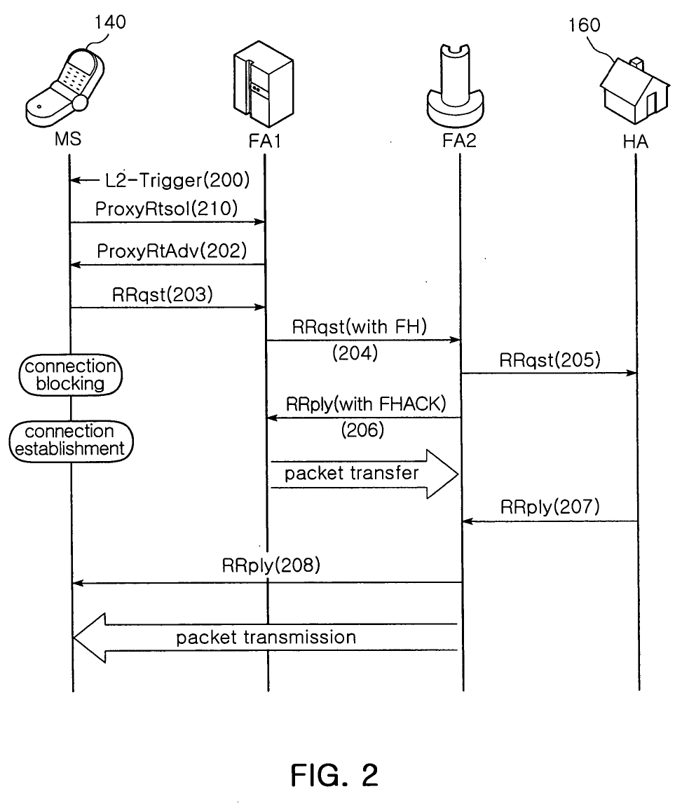

FIG. 2 is a diagram showing a message call processing flow in the method for MIPv4-based fast handoff between heterogeneous wireless networks in accordance with the embodiment of the present invention.

The handoff method of the present invention modifies the pre-registration scheme of low latency handoff and adopts the BET of the post-registration scheme. Furthermore, the pre-registration scheme of the low latency handoff substantially constitutes the main part of network-initiated handoff and employs a method using an L2-source trigger (which is generated in a currently connected FA) or an L2-target trigger (which is generated in a newly connected FA), whereas the present invention is related to mobile-initiated handoff and uses an L2-mobile trigger.

In FIG. 2, the MS 140 is a multi-mode terminal that supports multiple wireless access. An FA1 is an entity that functions as an FA, like the ACR 122 of the portable Internet service network 120, or the AR 132 of the PWLAN service network 120 into which APs 131 are concentrated, and an FA2 is assumed to be the PDSN 113 of the CDMA mobile communication service network 110. However, it can be understood that the FA1 or FA2 may correspond to any one of the FAs 113, 122 and 132. The FA1 and the FA2 are previously aware of mutual information by sharing the mutual information through router discovery. When the MS 140 performs L2 handoff in response to an L2 trigger, a handoff procedure is initiated. With reference to FIG. 2, the message call processing procedure in the method for MIPv4-based fast handoff between heterogeneous wireless networks in accordance with the embodiment of the present invention is described in detail below.

A handoff procedure is initiated by the generation of an L2-mobile trigger in the wireless link layer of the MS 140 at step 200. Then the MS 140 transfers a proxy router solicitation (ProxyRtSol) message, which requests information about the FA2 to be newly connected, to the FA1 previously connected, based on information acquired from the trigger. The proxy router solicitation message includes the link Identification (ID) of a wireless access network to which handoff is attempted. In the case of accessing the CDMA mobile communication wireless Internet access service network 110, a 5-byte Access Network ID (ANID) including a 2-byte System ID (SID), a 2-byte Network ID (NID) and a 1-byte Packet Zone ID (PZID) may be used. In the case of accessing the portable Internet service network 120, a 6-byte Base station ID may be used. In the case of accessing the PWLAN service network 130, a 6-byte Media Access Control (MAC) address may be used.

Thereafter, when the FA1 receives the proxy router solicitation message, the FA1 replies to the proxy router solicitation message with a proxy router advertisement message that includes the CoA of the FA2 corresponding to the link ID that the MS 140 requested, at step 202. That is, the proxy router advertisement message includes information about the FA2. The CoA is an address that is assigned whenever the MS 140 moves to a new network, and is different from a home address.

The MS 140 finds the CoA of the FA2 from the proxy router advertisement message received from the FA1 and transmits a registration request (RRqst) message to the FA1 at step 203.

The FA1 transfers a registration request with a fast handoff extension (RRqst with FH) message to the integrated HA through the FA2. The fast handoff extension corresponds to an IP extension for generating a tunnel between the previously connected FA1 and the FA2 to be newly connected. The fast handoff extension includes information about the generation of the tunnel and the IP address of the edge of the tunnel. The FA1 detects handoff through the fast handoff extension, and transfers a registration request message to the FA2, which is indicated in the fast handoff extension, to request the bi-directional edge tunnel, at step 204.

Subsequently, the FA2 transfers the registration request to the integrated HA 160 at step 205.

Furthermore, the FA2 accepts the tunnel generation request and generates the tunnel in such a way as to transfer the registration request message to the integrated HA 160 and to transmit a temporary registration reply message, together with a fast handoff acknowledge extension message, to the FA1 in reply to the tunnel generation request, at step 206. Then the FA1 can transfer packets, which will be received by the MS 140, to the FA2 through the tunnel until a mobile IP registration procedure is completed. That is, after a connection to a service has been blocked, the MS 140 can reestablish the connection using the generated tunnel.

Thereafter, the integrated HA 160 transfers a general mobile IP registration reply message to the FA2 at step 207.

Thereafter, the FA2 completes the mobile IP registration procedure by transferring a general registration reply message to the MS 140. When this procedure is completed, the FA2 can transmit packets to the MS 140.

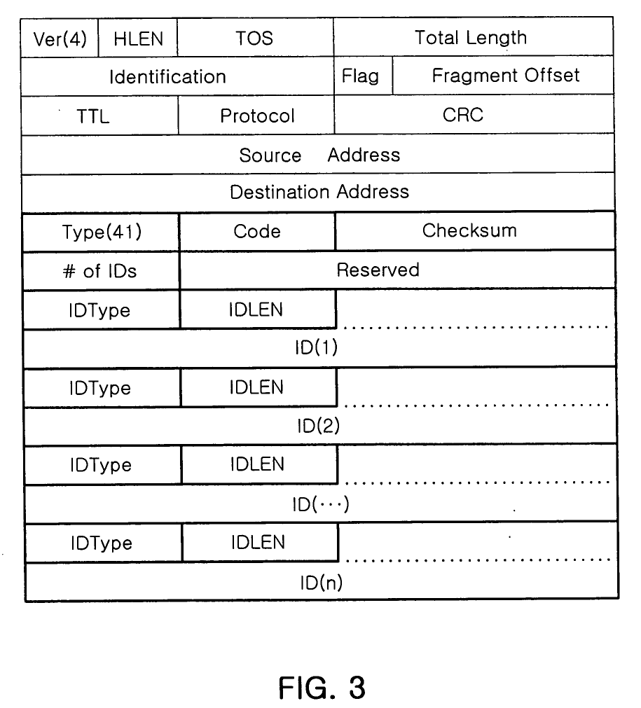

FIG. 3 is a diagram showing the format of a proxy router solicitation message according to an embodiment of the present invention.

Referring to FIG. 3, the proxy router solicitation message according to the embodiment of the present invention includes the following information. A Type is entered with “41” to designate the proxy router solicitation message that is one of the fields reserved by the Internet Assigned Numbers Authority (IANA). A one-byte Code value is set to “0,” and a Checksum is calculated in the same manner as the checksum of an IP header and the checksum of all the packets is entered therein. The Number of IDs field indicates the number of link IDs included. A Reserved field is a field-not in use and may be used for a specific use later. 8-byte ID fields are added in proportion to the number of link IDs later.

In the case of the link ID of a general wireless access network, a 5-byte ANID, including a 2-byte SID, a 2-byte NID and a 1-byte PZID, may be used for CDMA-based mobile communication access, a 6-byte base station ID may be used for a WiBro network and a 6-byte MAC address may be used for a WLAN, so that a maximum of a 6-byte ID region is defined, and a 1-byte ID Type and a 1-byte IDLEN are used to designate an ID type and an ID length, respectively.

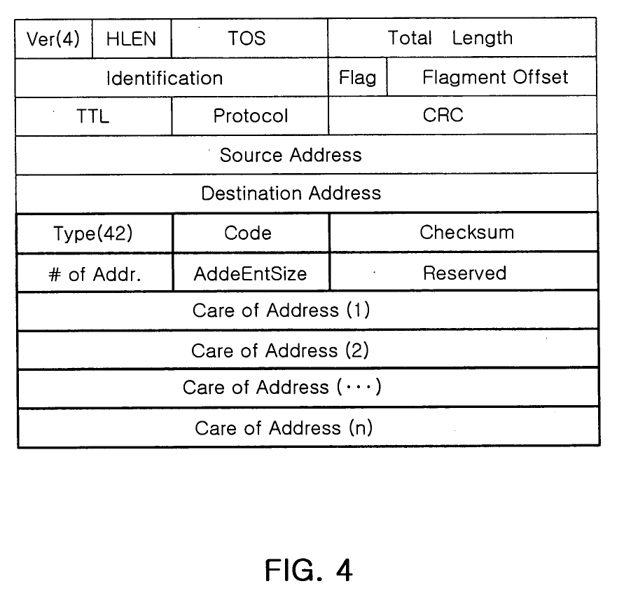

FIG. 4 is a diagram showing the format of a proxy router advertisement message according to an embodiment of the present invention.

Referring to FIG. 4, the proxy router solicitation message according to the embodiment of the present invention includes the following information. A Type is entered with “42” to designate the proxy router advertisement message that is one of the fields reserved by the IANA. A 1-byte Code value is set to “0” if a care-of address corresponds to a link ID that is requested by the MS. If not, an actual communication service provider assigns a different value to the 1-byte Code value according to the situation during application, thus notifying the MS of current status. A Checksum is calculated in the same way as the checksum of an IP header, and is entered with the checksum of all the packets. In the Number of Addresses, the number of CoAs contained in a message may be designated, and a reference level, other than the CoA, may be designated according to AddrEntSize. Generally, a 4-byte IP address is represented by “1.” In the CoA field, the CoAs of link IDs requested by the proxy router solicitation message of the MS are sequentially indicated, and null values are filled for an unknown link ID.

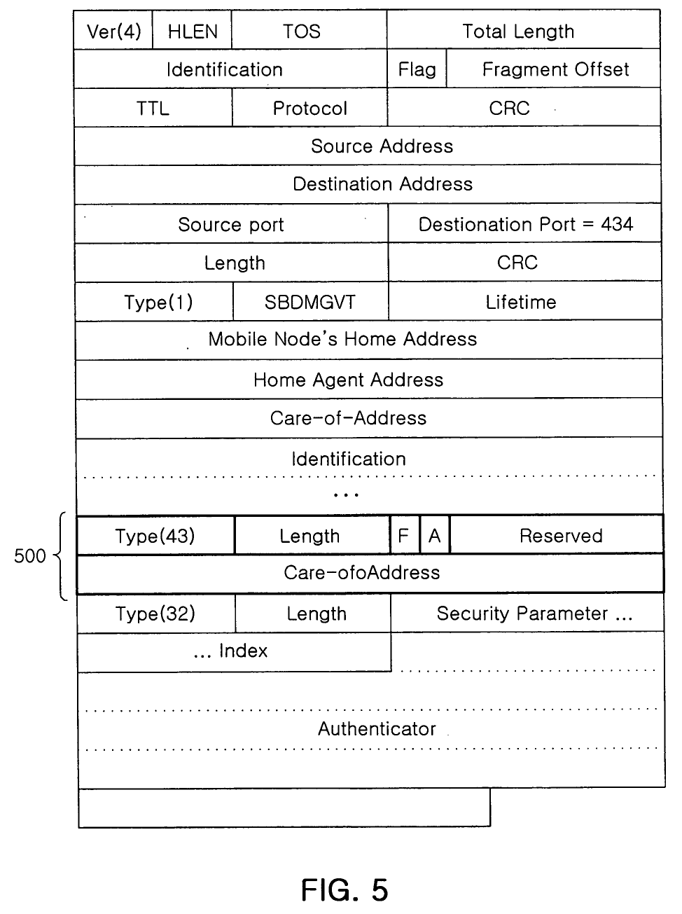

FIG. 5 is a diagram showing the format of a registration request message that is added with a fast handoff extension and is used in MIPv4, in accordance with an embodiment of the present invention.

Referring to FIG. 5, the registration request message requests the generation of a tunnel from the newly connected FA2 by setting an F bit in a form that is newly added with a fast handoff extension 500.

The definitions and values of the fast handoff extension 500 are used as follows. A Type uses “43” to designate the fast handoff extension that is one of the fields reserved by the IANA. A Length indicates the entire length of the fast handoff extension, and an F bit is set to “1” to request the generation of a tunnel. Since an A bit is used for a reply to the request for the generation of the tunnel, the A bit is set to “0.” A Reserved field corresponds to a field not in use and may be used for a specific use later. A CoA indicates the IP address of the edge of the tunnel. That is, the CoA is the IP address of the previous FA.

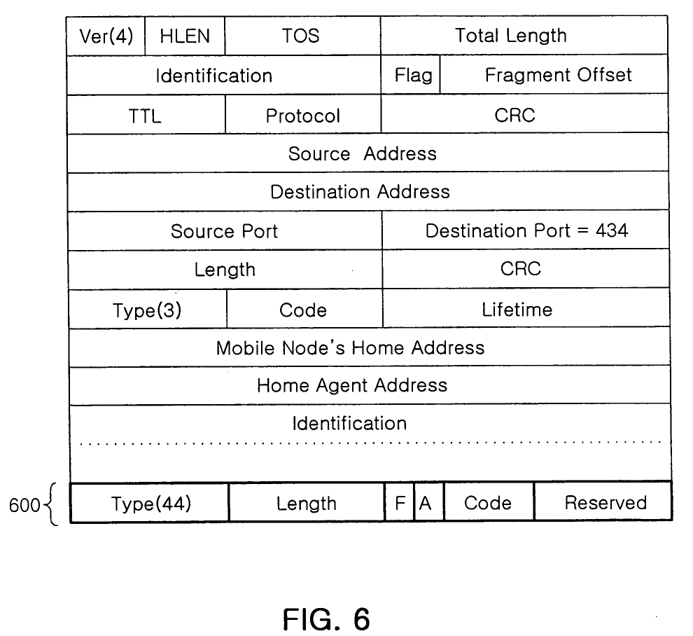

FIG. 6 is a diagram showing the format of a registration reply message that is added with a fast handoff acknowledge extension and is used in MIPv4, in accordance with an embodiment of the present invention.

Referring to FIG. 6, the registration reply message indicates a reply message by setting an A bit in a form that is newly added with a fast handoff acknowledge extension 600.

The definitions and values of the fast handoff acknowledge extension 600 are used as follows. A Type uses “44” to designate the fast handoff acknowledge extension that is one of the fields reserved by the IANA. A Length indicates the entire length of the fast handoff acknowledge extension, and an F bit is set to “0” to be used to request the generation of a tunnel. An A bit is set to “1” to reply to the request for the generation of the tunnel. A Code is used to indicate the result of a reply to the request for the generation of the tunnel. When the Code is set to “0,” the Code indicates success, and when the Code is set to “1,” the Code indicates failure. A Reserved field is a field not in use, and will be utilized later by a communication service provider according to the cause of failure in the generation of a tunnel or network setting information.

The method for MIPv4-based fast handoff between heterogeneous networks according to the present invention may be implemented using computer-readable code stored in one of computer-readable recording media. The computer-readable media include all types of recording devices in which data readable by a computer system are stored. The computer-readable recording media are exemplified by Read-Only Memory (ROM), Random Access Memory (RAM), Compact Disk (CD)-ROM, a magnetic tape, a floppy disk and an optical data recording device. The computer-readable recording media includes a carrier wave form, such as transmission via the Internet. Furthermore, a computer-readable recording medium may be distributed throughout a computer system connected via a network, so that computer-readable code can be stored and executed in a distributed manner.

As described above, in accordance with the present invention, when performing handoff between the heterogeneous networks, the MS uses the L2 trigger as a signal indicating the generation of the handoff, and can perform the MIPv4 registration procedure during L2 handoff, so that there is an advantage in that the delay in the mobile IP registration process can be considerably reduced.

Furthermore, in accordance with the present invention, the tunnel is generated between the previously connected FA and the FA to be newly connected and packets are transmitted to the MS through buffering even though the registration procedure is not completed, so that there is an advantage in that the loss of packets can be prevented, and the packets are transmitted immediately when the MS is link-connected to a new wireless network, so that there is an advantage in that the continuance of the service can be maintained.

As a result, in accordance with the present invention, fast handoff that is more stable and can guarantee QoS can be performed between the heterogeneous networks that are being diversified to provide broadband wireless Internet service.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for Mobile Internet Protocol version 4 (MIPv4)-based fast handoff between heterogeneous networks, comprising:
the first step of a Mobile Station (MS) acquiring information about a second Foreign Agent (FA) pertaining to a second wireless network to be newly accessed from a first FA pertaining to a first wireless network that is different from the first wireless network and is previously accessed;
the second step of the MS requesting registration from an integrated Home Agent (HA) through the first FA and the second FA;
the third step of generating a temporary tunnel between the first FA and the second FA; and
the fourth step of the HA transmitting a reply to the registration request to the MS through the second FA.

2. The method as set forth in claim 1, where the first step includes the steps of:
the MS transferring a proxy router solicitation message requesting information about the second FA to the first FA to which the MS has been previously connected; and
the first FA1 replying to the proxy router solicitation message of the MS with a proxy router advertisement message having information about the second FA that corresponds to a link Identification (ID).

3. The method as set forth in claim 2, wherein the proxy router solicitation message includes the link ID of the second wireless network to be newly connected.

4. The method as set forth in claim 3, wherein the proxy router advertisement message includes a Care-of Address (CoA) of the second FA that corresponds to the link ID.

5. The method as set forth in claim 3, wherein the link ID is an Access Network ID (ANID), including a System ID (SID), a Network ID (NID) and a Packet Zone ID (PZID), when the second wireless network is a Code Division Multiple Access (CDMA) mobile communication network.

6. The method as set forth in claim 3, wherein the link ID is a base station ID when the second wireless network is a portable Internet service network.

7. The method as set forth in claim 3, wherein the link ID is a MAC address when the second wireless network is a Public Wireless Local Area Network (PWLAN).

8. The method as set forth in claim 1, wherein the second step comprises the step of the first FA requesting registration from the integrated HA through the second FA using a registration request message, including a fast handoff extension.

9. The method as set forth in claim 8, wherein the fast handoff extension includes information about the generation of the tunnel and an Internet Protocol (IP) address of an edge of the tunnel.

10. The method as set forth in claim 1, wherein the third step is performed by the second FA transmitting a temporary registration reply request message, including a fast handoff acknowledge extension, to the first FA.

11. The method as set forth in claim 10, wherein the fast handoff acknowledge extension includes a region for the reply to the request for the generation of the tunnel and information about whether the generation of the tunnel has been successful.

12. A system for MIPv4-based fast handoff between heterogeneous networks, comprising:
an MS capable of accessing a plurality of heterogeneous networks;
a first FA pertaining a first wireless network that is previously accessed by the MS, the first FA being configured to process routing and mobile IP and to provide information about a second wireless network that is different from the first wireless network and will be accessed by the MS;
a second FA pertaining to the second wireless network, the second FA being configured to process routing and mobile IP and to generate a tunnel through which packets will be transferred to the MS; and
an integrated HA connected to the plurality of heterogeneous networks through an IP network, the integrated HA being configured to register information about a location of the MS so as to continuously provide a service as the MS moves through the heterogeneous networks.

13. The system set forth in claim 12, wherein the plurality of heterogeneous networks includes a CDMA mobile communication wireless Internet service network, a portable Internet service network and an IEEE 802.11-based PWLAN service network.

14. The system set forth in claim 12, further comprising an integrated Authentication, Authorization and Accounting (AAA) server for providing AAA services to subscribers who access the heterogeneous networks to use service.
